(19) United States
(12) Patent Application Publication
(10) Pub. No.: US 2014/0326099 A1
(43) Pub. Date: Nov. 6, 2014

(54) DRIVING MECHANISM

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: CHIA-PENG DAY, Santa Clara, CA (US); XIAO-MING XU, Shenzhen (CN); HUA HUANG, Shenzhen (CN)

(73) Assignees: HONG FU JIN PRECISION INDUSTRY (ShenZhen) CO., LTD., Shenzhen (CN); HON HAI PRECISION INDUSTRY CO., LTD., New Taipei (TW)

(21) Appl. No.: 14/270,434

(22) Filed: May 6, 2014

(30) Foreign Application Priority Data
May 6, 2013 (CN) 2013101620469

(51) Int. Cl. B23Q 16/00

(52) U.S. Cl. CPC B23Q 16/00
USPC 74/490.09

(57) ABSTRACT

A compact and gearless driving mechanism with a reduced operational envelope includes a support frame and two driving assemblies. The support frame includes a top plate and a bottom plate. Each driving assembly includes a first linear driving module, a second linear driving module intersecting with the first, and a third linear driving module intersecting with the second. The first linear driving module drives the second linear driving module to move along the first linear driving module, the second linear driving module drives the third linear driving module to move along the second linear driving module. A driving direction of each third linear driving module is inclined relative to the driving directions of the first linear driving module and the second linear driving module.

### CROSS-REFERENCE TO RELATED APPLICATIONS

This application is related to three co-pending U.S. patent applications (Attorney Docket Nos. US51919, US51920, US51921), entitled “ROBOT”, “DRIVING MECHANISM”, “THREE-AXES ROBOT”, respectively, by Day et al. The applications have the same assignee as the instant application and are concurrently filed on the same day. The disclosure of the above-identified applications is incorporated herein by reference.

### FIELD

The present disclosure relates to driving mechanisms, and particularly to a small sized driving mechanism.

### BACKGROUND

A driving mechanism can be applied to industrial processes, and particularly applied to heavy processes, repetitive processes, or special process environments, for example. A driving mechanism can be used in assembly of an electronic device, such as mobile phone, for example. However, electronic devices for example smart phones and tablet computers are gradually becoming thinner, and the assembling, machining, or handling of such electronic devices becomes harder and requires greater precision. Driving mechanism may drive along a plurality of directions, for example, driving mechanism may use a plurality of gears or reducers for transmitting movements. However, gears and reducers add weight and bulk and such a driving mechanism produces a lot of vibrations.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 is an isometric view of a first embodiment of a driving mechanism.

FIG. 2 is an exploded, isometric view of the driving mechanism of FIG. 1.

FIG. 3 is an isometric view of a second embodiment of a driving mechanism.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

The term “coupled” is defined as being connected, whether directly or indirectly, through intervening components, and is not necessarily limited to physical connections. The connection can be such that objects are permanently connected or releasably connected.

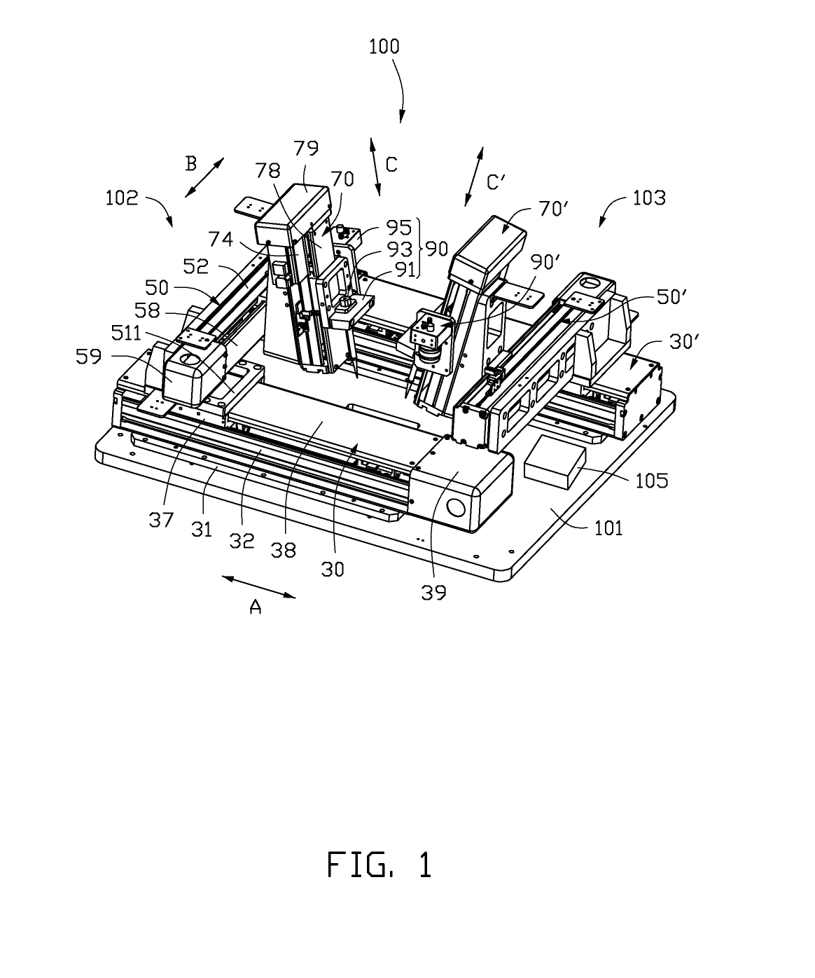

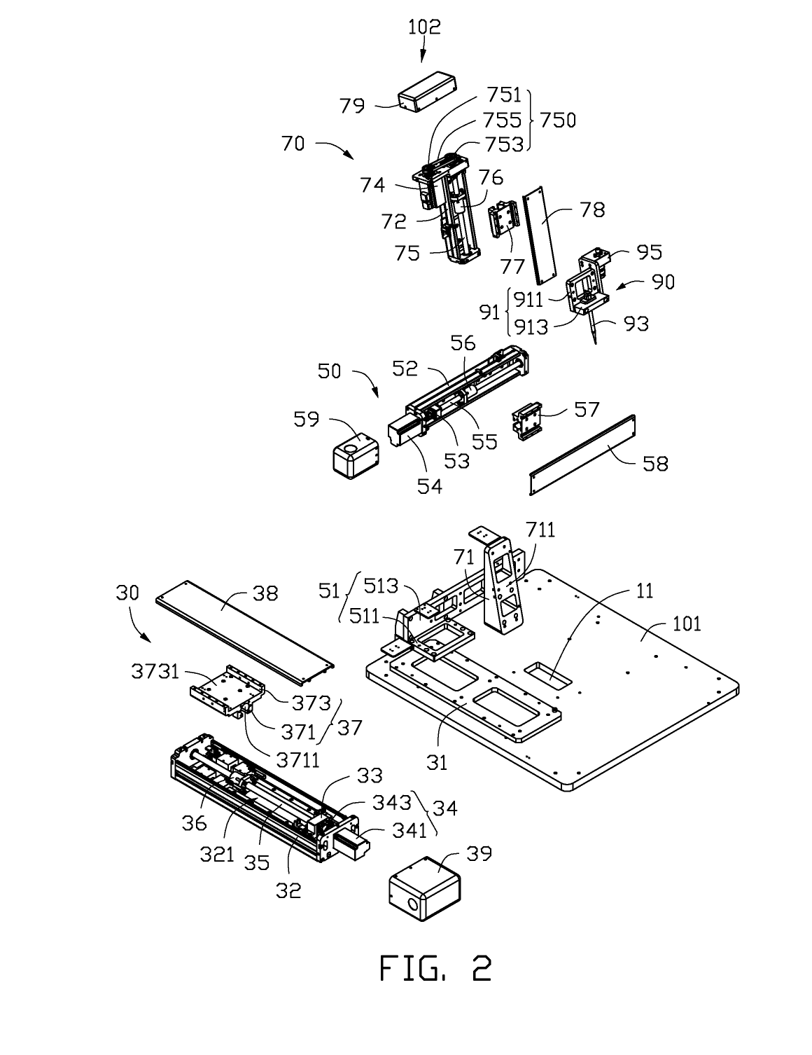

FIGS. 1 and 2 illustrate a first embodiment of a driving mechanism 100. The driving mechanism 100 includes a support member 101, a first driving assembly 102, a second driving assembly 103, and at least one controller 105 (schematically shown in FIG. 1). The first driving assembly 102, the second driving assembly 103, and the at least one controller 105 can be mounted on the support member 101. The first driving assembly 102 and the second driving assembly 103 can be electrically coupled to the at least one controller 105. A first actuating mechanism 90 can be coupled to the first driving assembly 102, and a second actuating mechanism 90′ can be mounted to the second driving assembly 103. The first driving assembly 102 and the second driving assembly 103 can be controlled by the at least one controller 105 to do tasks, such as detect and pick up, assemble, or machine, in relation to a workpiece. In the illustrated embodiment, the first actuating mechanism 90 and the second actuating mechanism 90′ detect a workpiece (not shown). The support member 101 is substantially a rectangular plate, and assembled on a worktable when in use. The support member 101 can support the first driving assembly 102 and the second driving assembly 103. The support member 101 can define a position hole 11 for positioning the workpiece. In an alternative embodiment, the workpiece can be positioned elsewhere, such as being positioned on a worktable (not shown) for example.

The first driving assembly 102 is largely a copy of the second driving assembly 103, thus only the first driving assembly 102 is explained in detail. The first driving assembly 102 can include a first linear driving module 30, a second linear driving module 50, and a third linear driving module 70. The first linear driving module 30 can be mounted on the support member 101. The second linear driving module 50 can be mounted on the first linear driving module 30. The third linear driving module 70 can be mounted on the second linear driving module 50 and coupled with the first actuating mechanism 90. The first linear driving module 30 can drive the second linear driving module 50 along a first direction A. The second linear driving module 50 can drive the third linear driving module 70 along a second direction B. The third linear driving module 70 can drive the first actuating mechanism 90 along a third direction C. For example, a driving direction of the third linear driving module 70 is along the third direction C. In the illustrated embodiment, the first direction A and the third direction C can be perpendicular to the second direction B. The third direction C is not required to be perpendicular to the first direction A. A moving direction of the first actuating mechanism 90 driven by the third linear driving module 70 can be inclined relative to a plane of movement of the third linear driving module 70. Because the third linear driving module 70 can move along the first direction A and the second direction B, the moving direction of the first actuating mechanism 90 driven by the third linear driving module 70 can be inclined relative to a plane parallel to the first direction A and the second direction B.

FIG. 2 illustrates that the first linear driving module 30 can include a connecting member 31, a mounting member 32, a connection reinforcing member 33, a driving member 34, a first transmission member 35, a second transmission member 36, a third transmission member 37, a protecting plate 38, or a protecting cover 39. The connecting member 31 can be substantially a rectangular plate. The connecting member 31 can be mounted on the support member 101 along the first direction A and located adjacent to an edge of the support member 101. The mounting member 32 can be substantially a frame and can define an opening 321 for mounting the connection reinforcing member 33, the driving member 34, the first transmission member 35, the second transmission member 36, the third transmission member 37, and the protecting plate 38. The mounting member 32 can be coupled to the connecting member 31 by fasteners for example. A longitudinal direction of the mounting member 32 can be parallel to the first direction A.

The connection reinforcing member 33 can be fixed to a distal end of the mounting member 32 and received in the opening 321. The driving member 34 can include a driving body 341 and a driving end 343 protruding from the driving body 341. The driving body 341 can be mounted on an end wall of the mounting member adjacent to the connection reinforcing member 33. The driving end 343 can be inserted through the end wall of the mounting member 32, to extend to the connection reinforcing member 33. Thus, the driving end 343 can be received in the mounting member 32. The first transmission member 35 can be substantially a rod and positioned in the mounting member 32 along the first direction A. A first end portion of the first transmission member 35 can be rotatably coupled to a wall of the mounting member 32 away from the connection reinforcing member 33, and a second end portion of the first transmission member 35 can be inserted through the connection reinforcing member 33 and coupled to the driving end 343 of the driving member 34. The connection reinforcing member 33 can be rotatably sleeved on a connecting portion of the first transmission member 35 and the driving end 343 for strengthening a connection between the first transmission member 35 and the driving end 343. The driving body 341 can rotate the driving end 343. Thus, the driving end 343 rotates the first transmission member 35. In the illustrated embodiment, the driving member 34 is a motor. The first transmission member 35 is a guiding lead screw.

The second transmission member 36 can be substantially cylindrical, and rotatably sleeved on the first transmission member 35 and threaded with the first transmission member 35. The third transmission member 37 can include a first fixing portion 371 and a second fixing portion 373 located upon the first fixing portion 371. The first fixing portion 371 can be substantially cylindrical, and define a through hole 3711 along a center axis thereof. The through hole 3711 can match with the second transmission member 36, and the first fixing portion 371 can be fixedly sleeved on the second transmission member 36 via the through hole 3711. The second fixing portion 373 can be substantially cuboid. Opposite sides of the second fixing portion 373 can be supported on sides of the mounting member 32 along the first direction A, such that the mounting member 32 can guide the second fixing portion 373 in operation. The second fixing portion 373 can define a receiving groove 3731 at a top surface. The protecting plate 38 can be a plate matching with the mounting member 32 and fixed on the mounting member 32. The protecting plate 38 can be partly received in the receiving groove 3731 to cover the opening 321, and to prevent dust and grease from entering into the mounting member 32. The protecting cover 39 covers the driving body 341 of the driving member 34, thereby preventing dust or grease from entering into the driving body 341.

A structure of the second linear driving module 30 can be similar to the first linear driving module 30. Thus, an explanation of the second linear driving module 50 is not required. The second linear driving module 30 can include a connecting member 51, a mounting member 52, a connection reinforcing member 53, a driving member 54, a first transmission member 55, a second transmission member 56, a third transmission member 57, a protecting plate 58, and a protecting cover 59. The connecting member 51 can be a frame and include a first connecting portion 511 and a second connecting portion 513 fixedly coupled to the first connecting portion 511. The first connecting portion 511 can be a substantially rectangular frame parallel to the support member 101. The first connecting portion 511 can be fixedly coupled to the second fixing portion 373 of the third transmission member 37. Thus, the connecting member 51 can move along the first direction A with the third transmission member 37. The second connecting portion 513 can be perpendicular to the first connecting portion 511, and a first end of the second connecting portion 513 can be coupled to the first connecting portion 511. A longitudinal direction of the second connecting portion 513 can be parallel to the second direction B. The respective structures or coupling relationships of the mounting member 52, the connection reinforcing member 53, the driving member 54, the first transmission member 55, the second transmission member 56, the third transmission member 57, the protecting plate 58, and the protecting cover 59 are the same as those of the mounting member 32, the connection reinforcing member 33, the driving member 34, the first transmission member 35, the second transmission member 36, the third transmission member 37, the protecting plate 38, and the protecting cover 39. Thus, explanations are omitted. The first transmission member 55 of the second linear driving module 50 can be positioned along the second direction B.

A structure of the third linear driving module 70 can be similar to that of the first linear driving module 30. Thus, an explanation of the third linear driving module 70 is simplified. The third linear driving module 70 can include a connecting member 71, a mounting member 72, a driving member 74, a first transmission member 75, an intermediate transmission assembly 750, a second transmission member 76, a third transmission member 77, a protecting plate 78, and a protecting cover 79. The connecting member 71 can be a substantially triangular prism and mounted on the third transmission member 57 of the second linear driving module 50, perpendicular to the support member 101. The connecting member 71 can include an inclined surface 711. The inclined surface 711 can be located at a side of the connecting member 71 away from the third transmission member 57. The inclined surface 711 can be inclined relative to the support member 101. A distance between the inclined surface 711 and the third transmission member 57 of the second linear driving module 50 can increase along a direction towards the support member 101. The inclined surface 711 can be positioned along the third direction C. The mounting member 72 can be fixed to the inclined surface 711. The driving member 74 can be mounted at a side surface of the mounting member 72 and parallel to the mounting member 72. The first transmission member 75 can be a rod, and opposite ends thereof can be mounted at sidewalls of the mounting member 72. The first transmission member 75 can be located along the third direction C.

The intermediate transmission assembly 750 can include a first transmission pulley 751, a second transmission pulley 753, and a transmission belt 755. The first transmission pulley 751 can be sleeved on a driving end of the driving member 74. The second transmission pulley 753 can be sleeved on a first end of the first transmission member 75 adjacent to the driving member 74. The transmission belt 755 can be sleeved on the first transmission pulley 751 and the second transmission pulley 753. The driving member 74 can rotate the first transmission pulley 751, the first transmission member 75 then being rotated by the transmission belt 755 and the second transmission pulley 753. The respective structures and coupling relationships of the first transmission member 75, the second transmission member 76, the third transmission member 77 and the protecting plate 78 can be substantially the same as those of first transmission member 35, the second transmission member 36, the third transmission member 37, and the protecting plate 38 of the first linear driving module 30. Thus, explanations of the first transmission member 75, the second transmission member 76, the third transmission member 77, and the protecting plate 78 are omitted. The first transmission member 75 of the third linear driving module 70 can be located along the third direction C. The protecting cover 79 can be mounted on a distal end of the mounting member 72 and cover the first transmission member 751, the second transmission member 753, and the transmission belt 755.

The second driving assembly 103 can also include a first linear driving module 30′, a second linear driving module 50′, and a third linear driving module 70′. The first linear driving module 30′ can be mounted on the support member 101 and located opposite to the first linear driving module 30. The first linear driving module 30′ can be located parallel to the first linear driving module 30′. Thus, the first linear driving module 30′ can be also arranged along the first direction A. The second linear driving module 50′ can be mounted on the first linear driving module 30′ and located opposite to the second linear driving module 50. The second linear driving module 50′ can be located parallel to the second linear driving module 50. Thus, the second linear driving module 50′ can be also arranged along the second direction B. The first linear driving module 30, the second linear driving module 50, the first linear driving module 30′, and the second linear driving module 50′ can together define a substantially rectangular hollow frame. Thus, a space occupied by the driving mechanism 100 in a plane parallel to the first linear driving module 30 and the second linear driving module 50 is small. The third linear driving module 70′ can be mounted on the second linear driving module 50′ and located opposite to the third linear driving module 70. The third linear driving module 70′ can be arranged along a fourth direction C′. The fourth direction C′ and the third direction C can be axisymmetrical about the axis perpendicular to the support member 101. A distal end of the third linear driving module 70 and a distal end of the third linear driving module 70′ can be close to each other. A structure of the first linear driving module 30′ can be substantially same as the structure of the first linear driving module 30. A structure of the second linear driving module 50′ can be substantially same as the structure of the second linear driving module 50. A structure of the third linear driving module 70′ can be substantially same as the structure of the third linear driving module 70. Coupling relationships of the first linear driving module 30′, the second linear driving module 50′, and the third linear driving module 70′ can be substantially the same as those of the first linear driving module 30, the second linear driving module 50, and the third linear driving module 70. Structures and coupling relationships of the first linear driving module 30′, the second linear driving module 50′, and the third linear driving module 70′ are as in the descriptions above.

In the illustrated embodiment, the number of the at least one controller 105 is one. The controller 105 can be electrically connected to the driving member 34 of the first linear driving module 30, the driving member 54 of the second linear driving module 50, the driving member 74 of the third linear driving module 70, a driving member of the first linear driving module 30′, a driving member of the second linear driving module 50′, and a driving member of the third linear driving module 70′. The controller 105 can control the above six driving members to work, such that the first driving assembly 102 and the second driving assembly 103 can simulate the dexterity of two human hands (for example in detect or in assembly) controlled by the controller 105. In an alternative embodiment, the controller 105 can be more than one, and then the more than one controller 105 can cooperatively control the first driving assembly 102 and the second driving assembly 103.

In assembly, the first linear driving module 30, the second linear driving module 50, the third linear driving module 70, the first linear driving module 30′, the second linear driving module 50′, and the third linear driving module 70′ are installed. When assembling the first linear driving module 30, the mounting member 32 can be fixed to the connecting member 31. The connection reinforcing member 33 can be fixed within the mounting member 32. The driving member 34 can be mounted on the mounting member 32 and located adjacent to the connection reinforcing member 33. The first transmission member 35 can be received in the mounting member 32 along a longitudinal direction of the mounting member 32. Opposite ends of the first transmission member 35 can be movably inserted through the mounting member 32, and the first transmission member 35 can be coupled to the driving end 343 of the driving member 34. A connecting portion of the driving end 343 and the first transmission member 35 can be received in the connection reinforcing member 33. The second transmission member 36 can be sleeved on the first transmission member 35 and threaded with the first transmission member 35. The third transmission member 36 can be fixed to the second transmission member 36. The protecting plate 38 can pass through the receiving groove 3731 and cover the opening 321 of the mounting member 32. The protecting cover 39 covers the driving member 34. When assembling the second linear driving module 50, the mounting member 52 can be fixed to the second connecting portion 513 of the connecting member 51. Other assembly steps of the second linear driving module 50 can be the same as the assembly steps of the first linear driving module 30. When assembling the third linear driving module 70, the mounting member 72 can be mounted on the inclined surface 711. The driving member 74 can be mounted on a sidewall of the mounting member 72. The first transmission member 75 can be inserted through the mounting member 72. The first transmission pulley 751 and the second transmission pulley 753 can be sleeved on the driving member 74 and the first transmission member 75, respectively. The transmission belt 755 can be wound over the first transmission pulley 751 and the second transmission pulley 753. Other assembly steps of the third linear driving module 30′ can be substantially the same as those for the first linear driving module 30. Assembling the first linear driving module 30′, the second linear driving module 50′, and the third linear driving module 70′ is as described above.

The assembled first linear driving module 30 and assembled first linear driving module 30′ can be mounted on the support member 101, and the first linear driving module 30 can be parallel to the first linear driving module 30′. The first connecting portion 511 can be perpendicularly fixed to the third transmission member 37 of the first linear driving module 30. The assembled second linear driving module 50 and assembled first linear driving module 50′ can be mounted on the support member 101, and the first linear driving module 30 can be parallel to the first linear driving module 30′. The first connecting portion 511 can be perpendicularly fixed to the third transmission member 37 of the first linear driving module 30, and the second linear driving module 50′ can be perpendicularly fixed to the first linear driving module 30′. The second linear driving module 50 and the second linear driving module 50′ can be located above the first linear driving module 30 and the first linear driving module 30′. The first linear driving module 30 and the second linear driving module 50 can form an L-shape together. The second linear driving module 50 and the second linear driving module 50′ can form an L-shape together, and then the first linear driving module 30, the second linear driving module 50, the first linear driving module 30′, and the second linear driving module 50′ together can form a hollow frame. The first linear driving module 30, the second linear driving module 50, the first linear driving module 30′ and the second linear driving module 50′ are arranged to be a substantially quadrilateral structure. The connecting member 70 of the third linear driving module 70 can be mounted on the third transmission member 57 of the second linear driving module 50. The third linear driving module 70 can be fixed to the second linear driving module 50′, and the third linear driving module 70 and the third linear driving module 70′ can be axisymmetrically arranged. The controller 105 can be positioned on the support member 101, and can be electrically coupled to the driving member 34 of the first linear driving module 30, the driving member 54 of the second linear driving module 50, the driving member 74 of the third linear driving module 70, the driving member of the first linear driving module 30′, the driving member of the second linear driving module 50′, and the driving member of the third linear driving module 70′.

In operation, the first actuating mechanism 90 and the second actuating mechanism 90′ can be mounted on the first driving assembly 102 and the second driving assembly 103, respectively. In the illustrated embodiment, the first actuating mechanism 90 and the second actuating mechanism 90′ are in a same structure. The first actuating mechanism 90 can include a mounting frame 91, an actuating member 93, and a camera 95. The actuating member 93 and the camera 95 can be mounted on the mounting frame 91. The mounting frame 91 can include a first plate 911 and a second plate 913 fixed to the first plate 911. The first plate 911 can be fixed to the third transmission member 77 of the third linear driving module 70 along the third direction C. Thus, the first plate 911 can be capable of moving along the third direction C when driven by the third transmission member 77. The second plate 913 can be perpendicular to the first plate 911. The actuating member 93 can be perpendicularly mounted on the second plate 913 and move along the third direction C with the mounting frame 91. In the illustrated embodiment, the actuating member 93 can be a probe for detecting the workpiece. The camera 95 can be fixed to the first plate 911 of the mounting frame 91. The camera can capture an image when the actuating member 93 detects the workpiece. The second actuating mechanism 90′ can be mounted on the third linear driving module 70′. The first actuating mechanism 90 and the second actuating mechanism 90′ can be located above the first linear driving module 30, the second linear driving module 50, the first linear driving module 30′, and the second linear driving module 50′. A workpiece (not shown) can be positioned in the positioning hole 11, and the actuating member 93 of the first actuating mechanism 90 and an actuating member of the second actuating mechanism 90′ can be located away from the positioning hole 11, and to prevent disturbing the positioning of the workpiece.

After the workpiece has been positioned, the controller 105 can control the driving body 341 of the first linear driving module 30 to rotate the driving end 343. Thus, the third transmission member 37 can move along the first transmission member 35 when driven by the second transmission member 36. Because the first transmission member 35 is located along the first direction A, the third transmission member 37 also moves along the first direction A. The third transmission member 37 can move the second linear driving module 50 along the first direction A. Thus, the first linear driving module 30 can drive the second linear driving module 50, the third linear driving module 70, and the first actuating mechanism 90 to move along the first direction A. The controller 105 can control the driving member 53 to enable the third linear driving module 70 and the first actuating mechanism 90 to move along the second direction B. The controller 105 can control the driving member 73 to enable the first actuating mechanism 90 to move along the third direction C. Thus, the actuating member 93 can move towards the workpiece. In the same way, the controller 105 controls the second actuating mechanism 90′ to move along the first direction A, the second direction B, and the fourth direction C′ by the first linear driving module 30′, the second linear driving module 50′, and the third linear driving module 70′, respectively. Therefore, the first actuating member 93 of the first actuating mechanism 90 and the second actuating member of the second actuating mechanism 90′ act together to detect the workpiece. The controller 105 controls the first driving assembly 102 and the second driving assembly 103 to simulate human hands in detecting the workpiece. The camera 95 of the first actuating mechanism 90 and a camera of the second actuating mechanism 90′ is activated on detection of the workpiece.

Because the linear driving modules of the first driving assembly 102 and the second driving assembly 103 are arranged on the support member 101 without interference, and driving directions of the third linear driving module 70 and third linear driving module 70′ are inclined, the driving mechanism 100 size is reduced. The driving mechanism 100 uses no gears or meshing structures, which also decreases a size and weight of the driving mechanism 100. In addition, the third linear driving module 70 and third linear driving module 70′ are inclined. Thus, the first actuating mechanism 90 and the second actuating mechanism 90′ can be inserted into a complex workpiece, for example, the actuating members can conveniently be inserted into an inclined hole defined on a vertical wall of the workpiece.

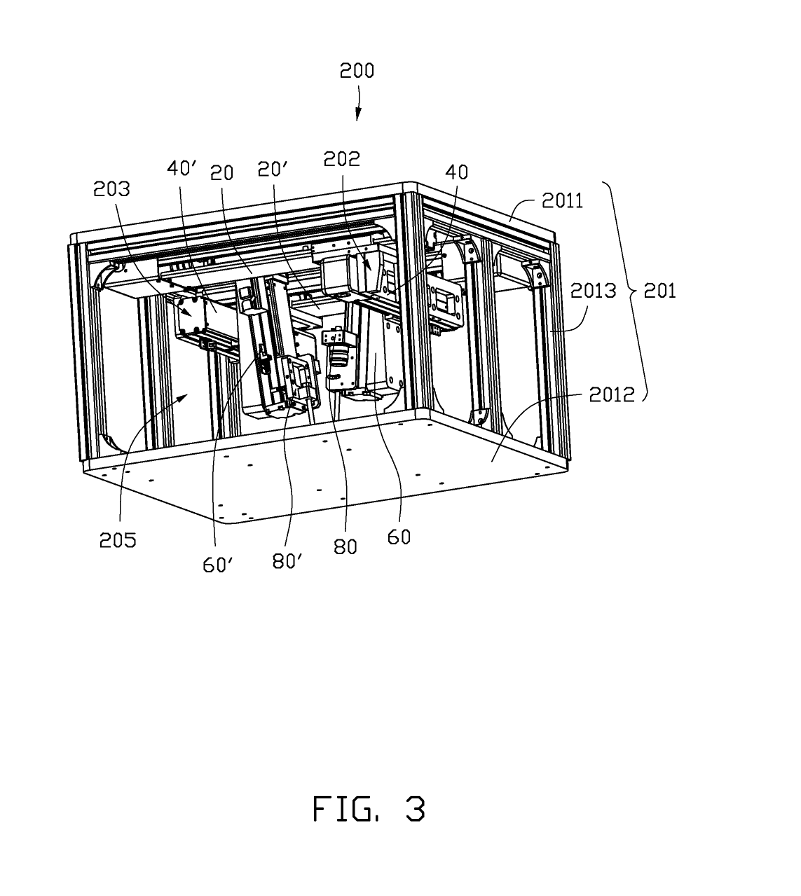

FIG. 3 illustrates a second embodiment of a driving mechanism 200, which is similar to the driving mechanism 100 of the first embodiment. The driving mechanism 200 can include a support frame 201, a first driving assembly 202, a second driving assembly 203, a first actuating mechanism 80, a second actuating mechanism 80′, and a controller 105. The support frame 201 can include a top plate 2011, a bottom plate 2012, and a plurality of coupling rods 2013. The top plate 2011 and the bottom plate 2012 can be parallel to each other. The coupling rods 2013 can interconnect the top plate 2011 and the bottom plate 2013. The top plate 2011, the bottom plate 2012, and the coupling rods 2013 can together define a receiving chamber 2015. The first driving assembly 202, the second driving assembly 203, and the controller 105 can be mounted on the top plate 2011 of the support frame 201 and be received in the receiving chamber 2015. Structures and relationships of the first driving assembly 202, the second driving assembly 203, the first actuating mechanism 80, the second actuating mechanism 80′ and the controller 105 are the same as the structures and relationships of the first driving assembly 102, the second driving assembly 103, the first actuating mechanism 90, the second actuating mechanism 90′, and the controller 105 of the first embodiment. Explanations of structures and relationships of the first driving assembly 202, the second driving assembly 203, the first actuating mechanism 80, the second actuating mechanism 80′, and the controller 105 are thus simplified.

The first driving assembly 202 can include a first linear driving module 20, a second linear driving module 40, and a third linear driving module 60. The second driving assembly 203 can include a first linear driving module 20′, a second linear driving module 40′, and a third linear driving module 60′. The first linear driving module 20 and the second linear driving module 20′ can be mounted on the top plate 2011 parallel to each other. The second linear driving module 40 can be slidably mounted on the first linear driving module 20 and located at a side of the first linear driving module 20 away from the top plate 2011. The second linear driving module 40′ can be slidably mounted on the first linear driving module 20′ and located at a side of the first linear driving module 20′ away from the top plate 2011. The first linear driving module 20, the second linear driving module 40, the first linear driving module 20′, and the second linear driving module 40′ together define a substantially rectangular frame. The third linear driving module 60 can be slidably mounted on the second linear driving module 40 and inclined relative to an imaginary plane parallel to a driving direction of the first linear driving module 20 and a driving direction of the second linear driving module 40.

The third linear driving module 60′ can be slidably mounted on the second linear driving module 40′ and inclined relative to an imaginary plane parallel to a driving direction of the first linear driving module 20′ and a driving direction of the second linear driving module 40′. The driving direction of the first linear driving module 20 can be parallel to the driving direction of the first linear driving module 20′. The driving direction of the second linear driving module 40 can be parallel to the driving direction of the second linear driving module 40′. A distance between the third linear driving module 60 and the third linear driving module 60′ decreases gradually along a direction towards bottom plate 2012. The distance between the third linear driving module 60 and the third linear driving module 60′ decreases in the downward direction. The first actuating mechanism 80 can be slidably mounted on the third linear driving module 60. A moving direction of the first actuating mechanism 80 can be inclined relative to an imaginary plane parallel to a moving direction of the second linear driving module 40 and a moving direction of the third linear driving module 60.

The second actuating mechanism 80′ can be slidably mounted on the third linear driving module 60′. A moving direction of the second actuating mechanism 80′ can be inclined relative to an imaginary plane parallel to a moving direction of the second linear driving module 40′ and a moving direction of the third linear driving module 60′. In the illustrated embodiment, the moving direction of the first actuating mechanism 80 and the moving direction of the second actuating mechanism 80′ can be axisymmetrical about an axis perpendicular to the bottom plate 2012. Structures and coupling relationships of the first linear driving module 20, the second linear driving module 40, the third linear driving module 60, the first actuating mechanism 80, the first linear driving module 20′, the second linear driving module 40′, the third linear driving module 60′, and the second actuating mechanism 80′ can be substantially the same as those of the first linear driving module 30, the second linear driving module 50, the third linear driving module 70, the first actuating mechanism 90, the first linear driving module 30′, the second linear driving module 50′, the third linear driving module 70′, and the second actuating mechanism 90′. Thus, an explanation of the structures and coupling relationships of the first linear driving module 20, the second linear driving module 40, the third linear driving module 60, the first actuating mechanism 80, the first linear driving module 20′, the second linear driving module 40′, the third linear driving module 60′, and the second actuating mechanism 80′ can be the same as that in the descriptions above.

When in operation, a workpiece can be mounted on the bottom plate 2012 of the support frame 201 and located between the first actuating mechanism 80 and the second actuating mechanism 80′. The controller 105 can control the first linear driving module 20, the second linear driving module 40, and the third linear driving module 60 to drive the first actuating mechanism 80 and control the first linear driving module 20′, the second linear driving module 40′, and the third linear driving module 60′ to drive the second actuating mechanism 80′. Thus, the first actuating mechanism 80 and the second actuating mechanism 80′ can cooperatively detect and/or machine the workpiece. Because linear driving modules of the driving mechanism 200 are located on the top plate 2011 of the support frame 201, a complex structure on the bottom plate 2012 is avoided and interference with outer or peripheral devices, such as a feeding device or conveyor for example, is also avoided.

In an alternative embodiment, the first linear driving module 30 of the first driving assembly 102 and the first linear driving module 30′ of the second driving assembly 103 can be the same. Thus, the second linear driving module 50 and the second linear driving module 50′ can be mounted on the same linear driving modules to move along the same straight line. The first linear driving module assembly 102 and the second linear driving module assembly 103 can be located on different planes at different heights, and the first linear driving module assembly 202 and the second linear driving module assembly 203 can be located on different planes at different heights. For example, the first driving assembly 202 can be located on the top plate 2011 and the second driving assembly 203 can be located on the bottom plate 2011, such that the first actuating mechanism 80 can be located at an end of the third linear driving module 60 adjacent to the bottom plate 2012, and the second actuating mechanism 80′ can be located at an end of the third linear driving module 60′ adjacent to the bottom plate 2012. The first linear driving module 30 and the first linear driving module 30′ can be located on different horizontal planes, the second linear driving module 50 and the second linear driving module 50′ can be located on different horizontal planes, and the third linear driving module 70 and the third linear driving module 70′ can be located at different heights. Thus, the first linear driving module 30 and the first linear driving module 30′ can be vertically staggered, the second linear driving module 50 and the second linear driving module 50′ can be vertically staggered, and the third linear driving module 70 and the third linear driving module 70′ can be vertically staggered, such that the first actuating mechanism 80 and the second actuating mechanism 80′ can be vertically staggered.

In an alternative embodiment, the connecting members 31, 51, 71, the connection reinforcing members 33, 53, the first transmission member 35, 55, 57, the second transmission members 36, 56, 76, the third transmission members 37, 57, 77, the first transmission pulley 751, the second transmission pulley 753, and the transmission belt 755 can be omitted, such that the mounting member 53 of the second linear driving module 50 can be directly coupled to the driving member 34, the mounting member 72 of the third linear driving module 70 can be directly coupled to the driving member 54, the first actuating mechanism 90 can be directly coupled to the driving member 74, and the driving members 34, 54, 74 can be motors. The third direction C and the fourth direction C′ can be inclined relative to the first direction A and the second direction B, and the inclined surface 711 and the inclined surface of the third linear driving module 70′ can be inclined relative to the first direction A and the second direction B. The first direction A can be non-perpendicular to the second direction B.

In an alternative embodiment, the third direction C and the fourth direction C′ can be inclined at different degrees relative to the first direction. The driving mechanism 100 can include more than two driving assemblies to according to different requirements. For example, the driving mechanism can include more than two driving assemblies to enable operations on many portions of an inner sidewall of an electronic device at the same time.

It is believed that the present embodiments and their advantages will be understood from the foregoing description, and it will be apparent that various changes can be made thereto without departing from the spirit and scope of the embodiments or sacrificing all of its material advantages.

What is claimed is:

1. A driving mechanism comprising:
at least two driving assemblies, each driving assembly comprising a first linear driving module, a second linear driving module intersecting with the first linear driving module, and a third linear driving module intersecting with the second linear driving module;
the first linear driving module being configured to drive the second linear driving module to move along the first linear driving module
the second linear driving module being configured to drive the third linear driving module long the second linear driving module,
a driving direction of the third linear driving module being inclined relative to a plane of the third linear driving module moving therein; and
at least one controller electrically coupled to the first linear driving module, the second linear driving module, and the third linear driving module, and the at least one controller configured to control the first linear driving modules, the second linear driving modules, the third linear driving modules to move.

2. The driving mechanism of claim 1, wherein the at least two driving assemblies comprises two driving assemblies;
the first linear driving modules of the two driving assemblies are located opposite to each other;
the second linear driving modules of the two driving assemblies are located opposite to each other;
the first linear driving modules of the driving assemblies and the second linear driving modules of the driving assemblies are arranged to be a quadrangle.

3. The driving mechanism of claim 2, wherein each linear driving module of the first linear driving modules, the second linear driving modules, and the third linear driving modules comprises a mounting member and a driving member mounted on the mounting member and electrically coupled to the at least one controller;
the mounting members of the first linear driving modules are located opposite to each other, the mounting members of the second linear driving modules are located opposite to each other and are coupled to the driving members of the first linear driving modules, respectively, the mounting members of the third linear driving modules are coupled to the driving members of the second linear driving modules, respectively;
the at least one controller is configured to control the driving members of the first linear driving modules, the second linear driving modules, and the third linear driving modules to move.

4. The driving mechanism of claim 3, wherein each linear driving module of the first linear driving modules, the second linear driving modules, and the third linear driving modules further comprises a first transmission member and a second transmission member threaded with the first transmission member;
each first transmission member is received in the corresponding mounting member and coupled to the corresponding driving member;
each second transmission member of the first linear driving modules is coupled to the corresponding mounting member of the second linear driving modules;
each second transmission member of the second linear driving modules is coupled to the corresponding mounting member of the third linear driving modules.

5. The driving mechanism of claim 4, wherein each linear driving module of the first linear driving modules, the second linear driving modules, and the third linear driving modules further comprises a connection reinforcing member mounted within the corresponding mounting member, each driving member comprises a driving body and a driving end coupled to the driving body, the driving body is coupled to the corresponding mounting member, each driving end is inserted into the corresponding mounting member and coupled to the corresponding first transmission member, each connection reinforcing member is sleeved on a connecting portion of the corresponding first transmission member and the corresponding driving end.

6. The driving mechanism of claim 3, wherein each third linear driving module further comprises a connecting member, each connecting member of the third linear driving modules is coupled to the corresponding mounting member of the second linear driving modules, each connecting member comprises an inclined surface located at a side away from the corresponding mounting member of the second linear driving modules, each mounting member of the third linear driving modules is coupled to the corresponding inclined surface.

7. The driving mechanism of claim 5, wherein each third linear driving module further comprises a middle transmission assembly, the middle transmission assembly comprises a first transmission pulley, a second transmission pulley, and a transmission belt;
the first transmission pulley is sleeved on a driving end of the driving member of the third linear driving module;
the second transmission pulley is sleeved on the first transmission member of the third linear driving module;
the transmission belt winds on the first transmission pulley and the second transmission pulley.

8. The driving mechanism of claim 1, wherein the driving mechanism further comprises a support frame, the support frame comprises a top plate and a bottom plate opposite to the top plate;
the first linear driving modules of the at least two driving assemblies are mounted on the top plate;
the at least two driving assemblies are located between the top plate and the bottom plate.

9. The driving mechanism of claim 1, wherein the driving mechanism further comprises a support frame, the support frame comprises a top plate and a bottom plate opposite to the top plate;
the first linear driving modules of the at least two driving assemblies are mounted on the top plate and the bottom plate, respectively;
the at least two driving assemblies are located between the top plate and the bottom plate.

10. A driving mechanism comprising:
a support frame comprising a top plate and, a bottom plate parallel to the top plate, the top plate, a receiving chamber being defined between the top plate and the bottom plate; and
two driving assemblies received in the receiving chamber,
each driving assembly comprising a first linear driving module, a second linear driving module intersecting with the first linear driving module, a third linear driving module intersecting with the second linear driving module;
the first linear driving module being configured to drive the second linear driving module to move along the first linear driving module;
the second linear driving module being configured to drive the third linear driving module long the second linear driving module,
a driving direction of the third linear driving module being inclined relative to a driving direction of the first linear driving module and a driving direction of the second linear driving module.

11. The driving mechanism of claim 10, wherein the first linear driving modules of the driving assemblies are located opposite to each other;
the second linear driving modules of the two driving assemblies are located opposite to each other;
the first linear driving modules of the two driving assemblies and the second linear driving modules of the driving assemblies are arranged to be a quadrangle.

12. The driving mechanism of claim 11, wherein each linear driving module of the first linear driving modules, the second linear driving modules, and the third linear driving modules comprises a mounting member and a driving member mounted on the mounting member;
the mounting members of the first linear driving modules are located opposite to each other;
the mounting members of the second linear driving modules are located opposite to each other and are coupled to the driving members of the first linear driving modules, respectively;
the mounting members of the third linear driving modules are coupled to the driving members of the second linear driving modules, respectively.

13. The driving mechanism of claim 12, wherein each linear driving module of the first linear driving modules, the second linear driving modules, and the third linear driving modules further comprises a first transmission member and a second transmission member threaded with the first transmission member, each first transmission member is received in the corresponding mounting member and coupled to the corresponding driving member;
each second transmission member of the first linear driving modules is coupled to the corresponding mounting member of the second linear driving modules; and
each second transmission member of the second linear driving modules is coupled to the corresponding mounting member of the third linear driving modules.

14. The driving mechanism of claim 13, wherein each linear driving module of the first linear driving modules, the second linear driving modules, and the third linear driving modules further comprises a connection reinforcing member mounted within the corresponding mounting member, each driving member comprises a driving body and a driving end coupled to the driving body, the driving body is coupled to the corresponding mounting member, each driving end is inserted into the corresponding mounting member and coupled to the corresponding first transmission member, each connection reinforcing member is sleeved on the corresponding first transmission member and the corresponding driving end.

15. The driving mechanism of claim 12, wherein each third linear driving module further comprises a connecting member, each connecting member of the third linear driving modules is coupled to the corresponding mounting member of the second linear driving modules, each connecting member comprises an inclined surface, each mounting member of the third linear driving modules is coupled to the corresponding inclined surface.

16. The driving mechanism of claim 14, wherein each third linear driving module further comprises a middle transmission assembly, the middle transmission assembly comprises a first transmission pulley;
a second transmission pulley, and a transmission belt, the first transmission pulley is sleeved on a driving end of the driving member of the third linear driving module;
the second transmission pulley is sleeved on the first transmission member of the third linear driving module;
the transmission belt winds on the first transmission pulley and the second transmission pulley.
